(19) United States
(12) Patent Application Publication
(10) Pub. No.: US 2007/0264413 A1
(43) Pub. Date: Nov. 15, 2007

(54) De-oiled whole grain products and processes for their production

(76) Inventors: Thomas P. Binder, Decatur, IL (US); Thomas Gottemoller, Mount Zion, IL (US); Richard Don Sullins, Olathe, KS (US); Russ Egbert, Decatur, IL (US)

Correspondence Address: Craig G. Cochenour, Esq.;Buchanan Ingersoll & Rooney PC, One Oxford Centre, 301 Grant Street, 20th Floor, Pittsburgh, PA, 15219, US

(21) Appl. No.: 11/801,643

(22) Filed: May 10, 2007

Related U.S. Application Data
(60) Provisional application No. 60/799,790, filed on May 12, 2006.

(51) Int. Cl. A23L 1/00

(52) U.S. Cl. 426/618; 426/622

(57) ABSTRACT

Novel grain processing methods and the products obtained therefrom are disclosed. High value oil streams are obtained by extraction during conventional corn dry milling. De-oiled whole grain products are disclosed.

### CROSS-REFERENCE TO RELATED APPLICATIONS

This Application claims the benefit of priority to pending U.S. Provisional Patent Application Ser. No. 60/799,790, filed on May 12, 2006, entitled “De-Oiled Grain Products and Processes For Their Production”, and having the same named inventors, namely Thomas P. Binder, Thomas Gottemoller, Richard Don Sullins, and Russ Egbert. U.S. Patent Application Ser. No. 60/799,790 is incorporated by reference into this Application as if fully rewritten herein.

### FIELD OF THE INVENTION

The present teachings relate to, but are not limited to, the field of corn product production. The invention relates, for example, to de-oiled flour and to other de-oiled corn products, as well as to methods for their production.

### BACKGROUND OF THE INVENTION

The following includes information that may be useful in understanding the present teachings. It is not an admission that any of the information provided herein is prior art, or material, to the presently described or claimed inventions, or that any publication or document that is specifically or implicitly referenced is prior art.

Corn oil has a number of properties and uses that are attractive to consumers and to producers of consumer products. Refined corn oil is crude corn oil from which fatty acids and phospholipids have been removed. Refined corn oil is reputed to have excellent frying quality and resist smoking and/or discoloration. Refined corn oil typically has a pleasant taste, resists development of off-flavors, and has a high polyunsaturated fat content. Refined corn oil has also been postulated to reduce blood cholesterol levels. Products such as margarines, salad oils, and cooking oils may include refined corn oil.

Corn dry milling, without ethanol production, typically involves addition of water to the corn kernel, increasing the moisture content to about 22%. Germ is made more resilient by the addition of water due to differential swelling relative to the other kernel components. The corn is treated (by abrasion or grinding) to break the kernel into bran (i.e. pericarp), germ, and endosperm fractions and the bran and germ containing fractions are separated from the endosperm fraction. Because the separation is not highly specific, the germ fraction contains a substantial amount of bran as well, so oil from corn dry milling includes a lower corn oil concentration per unit weigh due to the residual bran. In a so called “modified dry grind operation, the germ and bran and germ fractions are somewhat better separated than in common dry grind operations because the initial separation of the endosperm fraction typically employs a cyclonic separation chamber that efficiently removes the germ and bran fractions from the endosperm, and the bran an germ fractions are subsequently separated using a fluidized bed hopper system which facilitates better selection of a germ enriched fraction from a bran enriched fraction based on density. In any case, however, all dry grind operations are less economical for producing corn oil than corn wet milling operations because wet milling operations are much more effective at separating germ from the endosperm and bran than any type of dry mill process. On the other hand, dry grind operations, which are less expensive to establish than wet grain operations, are more economical for the production of starchy endosperm products such as flaking grits, brewing grits, cones, meal and flour. Due to the competitive advantages of oil production from wet milling, dry milling operations are generally not configured for producing or using oils from the germ containing fractions. Because of this, the germ and bran fractions obtained from dry grind operations are usually sold as ingredients for animal foods. A typical dry corn milling process is shown in FIG. 1.

Dry grind operations for other grains, such as wheat, oats, rye, millet, barley, sorghum, triticale, and rice operate on essentially the same principles as corn dry grind operations. One major difference however, is that the germ from these grains have much less oil than corn germ on a weight basis. This makes it economical to also make so called “whole grain” products from these other grains, which are dry grinds that contain the endosperm, bran and germ components in roughly equal proportions as they exist in the whole grain. Whole grain products as a food ingredient provide more fiber and protein than refined endosperm derived products such as flour and meal. The germ and bran fractions from corn are not typically incorporated into whole corn products on a large scale basis, because the amount of oil that is present in the germ will foul the product due to oxidation of the oil. In this regard, even whole grain flours made from other grains have a relatively short shelf life in comparison to refined flours because some residual oil from the germ is also present in these products.

It would be desirable to provide an improved dry corn milling process to make more economical use of the germ and bran fractions. It would also be desirable to produce whole grain products from corn with reduced oil so that the products do not suffer from fouling. It would further be desirable to extend the shelf life of whole grain products made from other grains by reducing the oil content of such products.

### BRIEF SUMMARY OF THE INVENTION

The inventions described and claimed herein have many attributes and encompass many embodiments including, but not limited to, those set forth in this Summary. The inventions described and claimed herein are not limited to or by the features or embodiments identified in this Summary, which is included for purposes of illustration only and not restriction.

In one aspect a de-oiled whole grain product is provided. In one embodiment, the whole grain product is a de-oiled whole grain meal. In a further embodiment, the whole grain product is a de-oiled whole grain flour. De-oiled whole grain flakes and grits may also be made. Other grains that may be de-germed include but at note limited to wheat, oats, rye, millet, barley, sorghum, triticale, and rice, and grain-like plants such as amaranth and buckwheat. Ground particle sizes could be uniform based on the machine that is used. Those skilled in the art will recognize that tempering and abrasion steps are often the common link between processing of these grains in the product, though how these steps are performed may vary for each grain.

De-oiled whole grain products may include, for example, whole grain products that include oil in an amount (by weight) selected from less than about 50%, less than about 40%, less than about 30%, less than about 25%, less than about 10%, less than about 5%, or less than about 1% of that of unprocessed grain product, where the whole grain products and the unprocessed grain products are from the same strain. De-oiled whole grain products may include, for example, whole grain products that include oil in an amount (by weight) selected from less than 50%, less than 40%, less than 30%, less than 25%, less than 10%, less than 5%, or less than 1% of that of unprocessed grain product, where the whole grain products and the unprocessed grain products are from the same strain.

In one aspect, an embodiment includes a method for producing a de-oiled whole grain product in a dry corn milling process, including the steps of:
(a) obtaining a grain;
(b) tempering the grain;
(c) degerminating tempered grain to produce an endosperm stream and at least one of a germ stream and a combined germ/bran stream;
(d) extracting oil from at least one of the germ stream and the germ/bran stream to produce oil and an oil extracted stream;
(e) combining the endosperm stream and the oil extracted stream to produce a de-oiled whole grain product.

Optionally in this aspect, the endosperm stream may be aspirated and/or sifted prior to combining with the oil extracted stream. A further aspect of the invention includes a method for producing a de-oiled whole grain product in a dry corn milling process, comprising extracting oil from a germ stream. The extracted oil may be processed further, made commercially available, or otherwise disposed of. The germ stream may be combined with other grain streams to make a whole grain product. Flour and flour products made by the above methods are also contemplated.

Extracting steps discussed herein may be performed, for example, using chemical extraction, expeller extraction, hydraulic press extraction, carbon dioxide-assisted extraction, and supercritical fluid extraction. Expeller extraction is preferred. Where supercritical fluid extraction is used, a preferred supercritical fluid is carbon dioxide. Supercritical fluid extraction may be performed with or without a cosolvent. If a cosolvent is used, it may be, for example, ethanol or propane. Methods of supercritical extraction are proposed, for example, in U.S. Pat. No. 4,495,207, to Christianson, et al., incorporated by reference herein.

Grains or grain-like raw materials for use with the teachings herein may include, for example, but are not limited to, wheat, millet, barley, sorghum, triticale, rice, corn, amaranth, buckwheat, and quinoa. Corn is preferred. No particular strain of corn is required. Exemplary corns for use in the invention include, for example, but are not limited to, white corn, yellow corn (U.S. #1 or U.S. #2), though of course the ease of tempering and germ removal will vary with the variety of corn that is used.

### BRIEF DESCRIPTION OF THE DRAWINGS

FIG. 1. FIG. 1 depicts a conventional dry mill corn milling process. (Singh, et al. “Modified Dry Grind Ethanol Process,” Publication of the Agricultural Engineering Dept. of Univ. of Ill. and Urbana-Champaign, UILU No. 2001-7021, Jul. 18, 2001, incorporated by reference herein.).

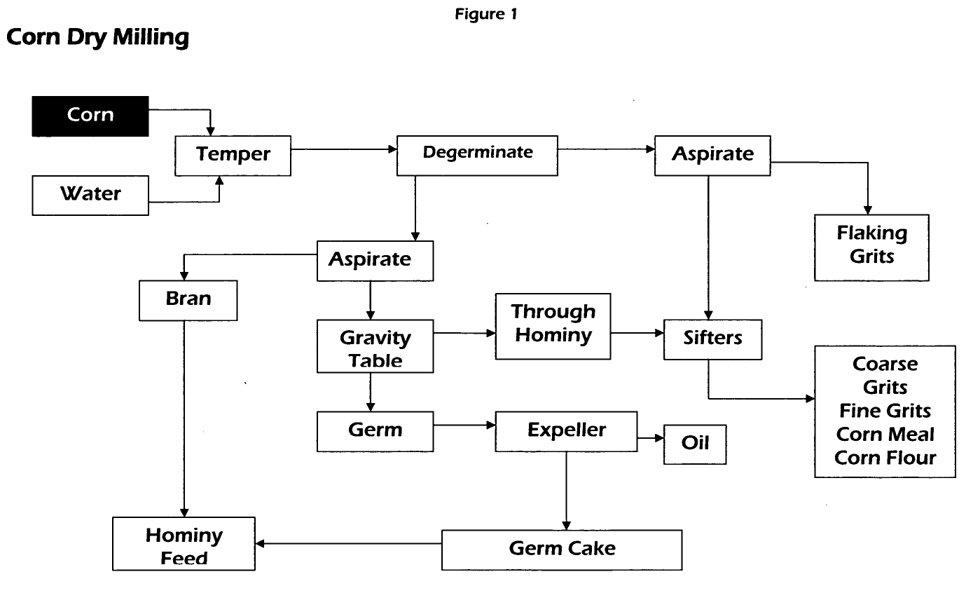

FIG. 2. FIG. 2 depicts an inventive process for the production of de-fatted corn flour.

### DETAILED DESCRIPTION OF THE INVENTION

### I. DEFINITIONS

To provide a clear and consistent understanding of the specification and claims, including the scope to be given to terms therein, the following definitions are provided. Note that the term “a” or “an” entity refers to one or more of that entity unless otherwise noted. As such, the terms “a,” “an,” “one or more,” and “at least one” can be used interchangeably herein.

As used herein, “de-oiled” means that a product contains less oil than the product would otherwise have contained had oil not been removed at some point during the production of the product.

As used herein, “grain products” includes but is not limited to at least one of grits, flours, cones, meals, and flakes. “Products” preceded by a specific grain, i.e. “corn products,” includes but is not limited to grits, flours, cones, meals and flakes made from that grain.

As used herein, “whole grain products” means one or more grain products including the intact, ground, cracked or flaked caryopsis, whose principal anatomical components: the starchy endosperm, germ and bran, are present in the same relative proportions as they exist in the intact caryopsis. This definition is that used by the American Association of Cereal Chemists.

### II. DISCUSSION

Discussion of the methods and compositions taught herein will be made using corn as an exemplary grain for the practice of the invention. Those skilled in the art will, with the benefit of this disclosure, recognize that the methods and compositions may be practiced with other grains and grain-like substances, as discussed herein. Grains or grain-like raw materials for use with the teachings herein may include, for example, but are not limited to, wheat, millet, barley, sorghum, triticale, rice, corn, amaranth, buckwheat, and quinoa. Corn is preferred. No particular strain of corn is required. Although the starting amount of oil in unprocessed grain product can vary based on degree of fractionation and process used, an approximate beginning oil content, by weight, for wheat germ is about 7%, for corn germ is between about 25 to about 50%, for rice germ is between about 15 to about 20%, and for oat germ is between about 15 to about 20%.

Conventional corn dry milling is an effective method for producing a number of corn products, including, for example, grits, cones, meals, flakes, and flours. Usually, however, these corn products are not “whole grain” products; instead they are almost entirely endosperm. The germ and, optionally, bran components of the corn are not added to the endosperm, because the oil content of the germ is so high that if it were included the grain products would spoil due to oxidation.

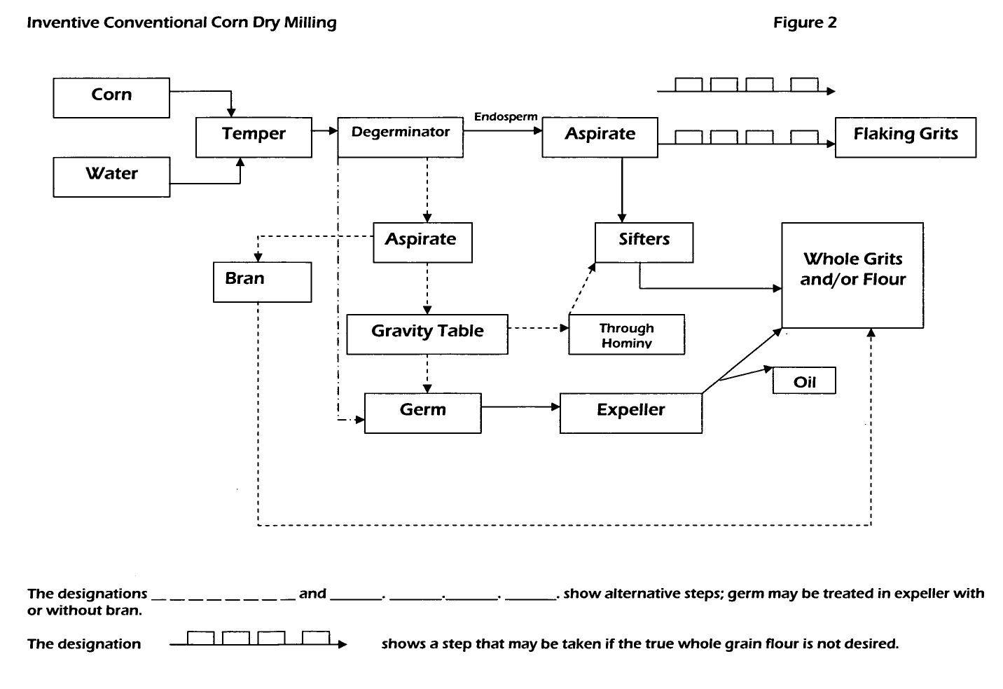

We have discovered that high quality, spoilage-resistant whole grain products may be made from the products of a dry milling operation. In one embodiment, high quality, spoilage-resistant whole grain corn products are made from the products of a corn dry milling operation. These products may be made, for example, by subjecting the germ to treatment to remove some of the oil in the germ. The de-oiled germ (and bran) is then combined with the endosperm to form a whole grain product. This treatment may be accomplished, for example, by chemical extraction, use of an expeller (also known as a screw press) with or without addition carbon dioxide injection, use of a mechanical or hydraulic press, or by supercritical fluid extraction. An exemplary process is shown in FIG. 2, though of course that depiction should not limit that which is claimed. For example, FIG. 2 depicts separation of the bran enriched stream from an germ stream by aspiration. This is not to imply that separation of a bran enriched stream from a germ enriched stream is necessary. All that is needed for the processes described herein is to extract oil from a fraction containing the germ to form a de-oiled stream, and that the components the de-oiled stream (and bran stream if separated) are added back to the endosperm stream to make the de-oiled whole grain product.

Use of an expeller in extraction is preferred. Hot pressing or cold pressing may be used. For hot pressing, the material may be heated as high as 70 to 80° C. Exemplary expeller conditions suitable for use in the invention are described, for example, in Bredeson, D. K., “Mechanical Extraction,” JAOCS, V. 55, November 1978, pp. 762-764; Said, N. W., “Dry Extrusion—Mechanical Expelling,” Inform, V. 9, No. 2, February 1998. Both are incorporated by reference herein.

Although it is not critical, ideally the extraction will be conducted at or near the mill. This allows the extraction to be conducted very shortly after separation of the germ and endosperm. Not only is this cost effective (due to reduced hauling charges), but it ensures that the oil in the germ has the lowest possible effect on the quality of the germ both before and after it is introduced into the whole grain product.

Those skilled in the art will recognize that the steps used in the conventional dry corn milling process are not critical, so long as oil is removed from the germ at some point prior to the creation of the whole grain product. In one embodiment, a conventional corn dry milling process includes at least the steps of:
(a) providing corn;
(b) tempering the corn;
(c) degerminating the tempered corn to produce an endosperm stream and a stream of combined germ and bran;
(d) extracting oil from the germ and bran stream to produce oil and an oil extracted germ and/or germ/bran stream;
(e) combining the endosperm stream and the oil extracted stream to produce a de-oiled whole grain product containing bran, germ and endosperm components.

The addition of steps may be contemplated. For example, following degermination the germ and bran stream may be aspirated to separate the bran and the germ. The bran may be added directly to the whole grain product, while the germ first proceeds through the oil extraction step. Similarly, a cleaning step may be added prior to tempering. One or more additional steps, such as grinding, sieving, flaking, air classification, aspiration, roll-lengthening, sizing, screening, sifting, or hammer-milling steps may also be included.

De-oiled whole grain products may include, for example, whole grain products that include oil in an amount (by weight) that is less than about 50%, less than about 40%, less than about 30%, less than about 20%, less than about 10%, less than about 5%, or less than about 1% of that of an unprocessed grain product that would otherwise be formed from combination of the germ and endosperm.

In one embodiment, a de-oiled whole corn flour is created. The de-oiled whole corn flour comprises, for example, by weight on a dry basis, about 60 to about 80% starch, about 0.01 to about 3% fat, about 5 to about 15% protein, about 1 to about 2% ash, and about 1 to about 3% sugar. The remainder is water. In a more preferred embodiment, de-oiled whole corn flour comprises, for example, by weight on a dry basis, from 69 to 75% starch, from 0.01 to 2.2% fat, from 8 to 12% protein, from 1.4 to 1.6% ash, and from 1.5 to 2.5 sugar, with the remainder being moisture.

### III. EXAMPLES

The examples below are only representative of some aspects of the invention. It will be understood by those skilled in the art that the invention as set forth in the specification can be practiced with a variety of equipment and unit operations. These examples should not be interpreted as limiting the invention in any way not explicitly stated in the claims.

### Example 1

Example 1 describes a prophetic example. Whole U.S. No. 2 corn is dry cleaned by passing over magnets to remove iron, then aspirated though a Kice aspirator to remove dust, fines and remaining cob. The corn is wet cleaned to remove residual dust and other filth and the moisture content is adjusted to about 20%. The corn after tempering has the bran, pericarp and germ abraded away in a Beall degerminator. Most of any bran or germ that sticks with the endosperm is removed then through aspirator and gravity tables.

The germ/bran/pericarp fraction is then dried and the oil is removed with the use of an expeller, such as a DeSmet Rosedown expeller press, with the oil removed further from the cake by extracting with a mixtures of hexanes through a Crown Model III extractor.

The endosperm and the germ/bran/pericarp, having been defatted by expeller and chemical extraction, are blended and ground though hammer mills and produced into grits for making a product such as tortilla chips. The deffated whole grain corn grits has an approximate composition of 75% starch, 0.1% fat, 12% protein, 1.6% ash, 2.5% sugars and 8.8% moisture.

Patents, patent applications, publications, scientific articles, books, web sites, and other documents and materials referenced or mentioned herein are indicative of the levels of skill of those skilled in the art to which the inventions pertain, as of the date each publication was written, and all are incorporated by reference as if fully rewritten herein. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, and the claims referred to above including but not limited to any original claims.

The inventions have been described broadly and generically herein. Each of the narrower species and subgeneric groupings falling within the generic disclosure also form part of these inventions. This includes the generic description of each invention which hereby include, including any claims thereto, a proviso or negative limitation removing or optionally allowing the removal of any subject matter from the genus, regardless of whether or not the excised materials or options were specifically recited or identified in haec verba herein, and all such variations form a part of the original written description of the inventions. In addition, where features or aspects of an invention are described in terms of a Markush group, the invention shall be understood thereby to be described in terms of each and every, and any, individual member or subgroup of members of the Markush group.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement was specifically and without qualification or reservation expressly adopted by Applicants in a responsive writing specifically relating to the application that led to this patent prior to its issuance.

The terms and expressions employed herein have been used as terms of description and not of limitation, and there is no intention in the use of such terms and expressions, or any portions thereof, to exclude any equivalents now know or later developed, whether or not such equivalents are set forth or shown or described herein or whether or not such equivalents are viewed as predictable, but it is recognized that various modifications are within the scope of the invention claimed, whether or not those claims issued with or without alteration or amendment for any reason. Thus, it shall be understood that, although the present invention has been specifically disclosed by preferred embodiments and optional features, modifications and variations of the inventions embodied therein or herein disclosed can be resorted to by those skilled in the art, and such modifications and variations are considered to be within the scope of the inventions disclosed and claimed herein.

Specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. Where examples are given, the description shall be construed to include but not to be limited to only those examples. It will be readily apparent to one skilled in the art that varying substitutions and modifications may be made to the invention disclosed herein without departing from the scope and spirit of the invention, and from the description of the inventions, including those illustratively set forth herein, it is manifest that various modifications and equivalents can be used to implement the concepts of the present invention without departing from its scope. A person of ordinary skill in the art will recognize that changes can be made in form and detail without departing from the spirit and the scope of the invention. The described embodiments are to be considered in all respects as illustrative and not restrictive. Thus, for example, additional embodiments are within the scope of the invention and within the following claims.

We claim:

1. A de-oiled whole grain product.

2. The de-oiled whole grain product of claim 1, wherein said de-oiled whole grain product is selected from the group consisting of de-oiled whole grain meal and de-oiled whole grain flour.

3. The de-oiled whole grain product of claim 1, wherein said de-oiled whole grain product includes oil in an amount (by weight) selected from the group consisting of less than about 50%, less than about 40%, less than about 30%, less than about 25%, less than about 20%, less than about 15%, less than about 10%, less than about 5%, or less than about 1% of that of an otherwise identical whole grain product that is not de-oiled.

4. A method for producing a de-oiled whole grain product in a dry corn milling process, comprising:
(a) obtaining a grain;
(b) tempering said grain;
(c) degerminating said grain to produce an endosperm stream and a at least one of a germ stream and a germ/bran stream;
(d) extracting oil from at lest one of the germ stream and the germ/bran stream to produce oil and an oil extracted germ and/or germ/bran stream;
(e) combining said endosperm stream and said oil extracted stream to produce a de-oiled whole grain product containing endosperm, bran and de-oiled germ components.

5. The method of claim 4 wherein the germ stream is separated from the germ/bran stream to form the germ enriched stream and a bran enriched stream, the germ enriched stream is de-oiled, and the de-oiled germ and bran enriched stream are combined with the endosperm stream.

6. A flour made by the method of claim 4.

7. The method of claim 4 wherein said extracting step is performed using a method selected from the group consisting of chemical extraction, expeller extraction, hydraulic press, mechanical press, carbon dioxide assisted expeller extraction, and supercritical fluid extraction.

8. The method of claim 7, wherein said extracting step is performed using supercritical fluid extraction, and wherein said supercritical fluid is carbon dioxide.

9. A method of any of claims 4wherein said grain is selected from the group consisting of wheat, millet, barley, sorghum, triticale, rice, corn, amaranth, and buckwheat.

10. The method of claim 9 wherein said grain is corn.

11. A de-oiled whole grain product of claim 1, wherein said grain is corn.

12. A de-oiled whole grain corn product comprising, by weight on a dry basis, about 60 to about 80% starch, about 0.01 to about 3% fat, about 5 to about 15% protein, about 1 to about 2% ash, and about 1 to about 3% sugar, with the remainder being water.

13. The de-oiled whole grain corn product of claim 12, comprising, by weight on a dry basis, from 69 to 75% starch, from 0.01 to 2.2% fat, from 8 to 12% protein, from 1.4 to 1.6% ash, and from 1.5 to 2.5 sugar, with the remainder being moisture.

14. The de-oiled whole grain corn product of claim 13, comprising, by weight on a dry basis, about 72% starch, about 1% fat, about 10% protein, about 1.5% ash, about 2.0% sugar, and about 13.5% water.

15. A de-oiled whole grain corn product comprising, by weight, 75% starch, 0.1% fat, 12% protein, 1.6% ash, 2.5% sugars and 8.8% moisture.
